(19) United States
(12) Patent Application Publication
(10) Pub. No.: US 2005/0111484 A1
(43) Pub. Date: May 26, 2005

(54) Mobile communication system, master base station and slave base station

(75) Inventor: Kiyoshi Obata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/824,541

(22) Filed: Apr. 15, 2004

(30) Foreign Application Priority Data
Nov. 21, 2003 (JP) 2003-392529

(51) Int. Cl. H04L 12/28

(52) U.S. Cl. 370/465; 370/328; 709/208; 455/561

(57) ABSTRACT

A mobile communication system is provided that can increase the number of radio base stations undergoing the group control, and enable multichannel connection without modifying a hardware configuration and without concentrating a control load on a master base station. In the system, only the master base station includes a radio circuit control channel controller for controlling radio circuit side control channels. Individual radio base stations including the master base station, which constitute a group control base station complex, each include a wired circuit control channel controller for controlling a wired circuit side control channel.

### BACKGROUND OF THE INVENTION

1. Field of the Invention

The present invention relates to a mobile communication system that includes a plurality of radio base stations constituting a group with a master-slave configuration, and has the master base station control the communication processing between the slave base stations and mobile communication terminals, and relates to the master base station and slave base stations constituting the system.

2. Description of Related Art

As a mobile communication system, in which a plurality of radio base stations communicating with mobile communication terminals are connected to a network via wired circuits, PHS (Personal Handyphone System) is known. Some of these mobile communication systems employ group control to implement multichannel communication connection of the mobile communication terminals.

To carry out the group control, a plurality of radio base stations comprise a group with a master-slave configuration, and the master base station controls the communication processing between the slave base stations and mobile communication terminals via wired circuits and a network. Thus, the multichannel connection is carried out with the mobile communication terminals via the traffic channels corresponding to the number of slave base stations in the group.

To perform the group control, the conventional mobile communication system carries out the centralized control of the wired circuits and radio circuits of the individual radio base stations subjected to the group control by the master base station (refer to Relevant Reference 1). In contrast, when the group control is not performed, the individual radio base stations control the wired circuits and radio circuits individually.
Relevant Reference 1: Japanese patent application laid-open No. 9-327066/1997

The conventional mobile communication system has a problem in that it sometimes cannot accommodate a desired number of radio base stations to be subjected to the group control. This is because since the master base station controls the wired circuits and radio circuits of the slave base stations collectively in the group control, the control load of the master base station increases proportionately with the number of the radio base stations to be subjected to the group control.

If the desired number of radio base stations to be subjected to the group control cannot be connected, even when the number of subscribers of the system increases and hence the traffic volume of the communication increases, the number of the traffic channels cannot match the increase, thereby being unable to cope with the changes in the traffic conditions flexibly. In addition, as for a system that must allot the radio circuit control channels, which are assigned to the individual radio base stations, to different time slots of the same channel, since the number of the time slots has an upper limit, the number of allottable radio circuit control channels has an upper limit, as well. Accordingly, there is also its limit in increasing the number of traffic channels by increasing the number of the radio base stations that transmit the radio circuit control channels.

In contrast with this, modifying the hardware of the master base station such as replacing its computer to a more powerful one can increase the number of the radio base stations to be subjected to the group control to a desired number.

However, the method has a problem in that it must revise the master base station to a hardware configuration with higher performance and cost every time the number of the radio base stations to be subjected to the group control is increased to cope with an increase in the traffic volume.

### SUMMARY OF THE INVENTION

The present invention is implemented to solve the foregoing problems. It is therefore an object of the present invention to provide a mobile communication system capable of increasing the number of the radio base stations to be subjected to the group control, and enabling the multichannel connection without changing the hardware configuration and without concentrating the control load on the master base station, and to provide a master base station and slave base stations configuring the system.

According to an aspect of the present invention, there is provided a mobile communication system including a plurality of radio base stations that are connected to a common telecommunication network via a wired circuit, and that communicate with mobile stations via radio circuits, the mobile communication system including: a master base station that consists of at least one of the plurality of radio base stations with the remaining radio base stations being set as slave base stations, and that includes a radio circuit side controller for carrying out control processing via the radio circuits, wherein all the radio base stations each include a wired circuit side controller for carry out control processing via the wired circuit.

With the configuration, all the radio base stations can each carry out the control processing via the wired circuit, thereby being able to scatter the load required for the wired circuit side control processing over the individual radio base stations.

Thus, it can prevent the concentration of the control load on the master base station. Therefore it offers an advantage of being able to increase the number of radio base stations undergoing the group control based on the master-slave configuration more easily than the conventional system. In addition, the present system offers an advantage of being able to implement the multichannel connection in accordance with the traffic conditions with ease.

Furthermore, as for the radio circuit side controller for carrying out the control processing via the radio circuits, since it is provided only in the master base station, an increase in the number of the radio base stations to be subjected to the group control does not bring about an increase of the control channels of the radio circuits. Therefore the system in accordance with the present invention offers an advantage of being able to make effective use of the resources of the control channels of the radio circuits whose time slots have an upper limit in their number.

### BRIEF DESCRIPTION OF THE DRAWINGS

FIG. 1 is a block diagram showing a configuration of an embodiment 1 of the mobile communication system in accordance with the present invention;

FIG. 2 is a block diagram showing a configuration of an embodiment 2 of the mobile communication system in accordance with the present invention;

FIG. 3 is a block diagram showing a configuration of an embodiment 3 of the mobile communication system in accordance with the present invention; and

FIG. 4 is a block diagram showing a configuration of an embodiment 4 of the mobile communication system in accordance with the present invention.

### DETAILED DESCRIPTION OF THE PREFERRED EMBODIMENTS

The invention will now be described with reference to the accompanying drawings.

### Embodiment 1

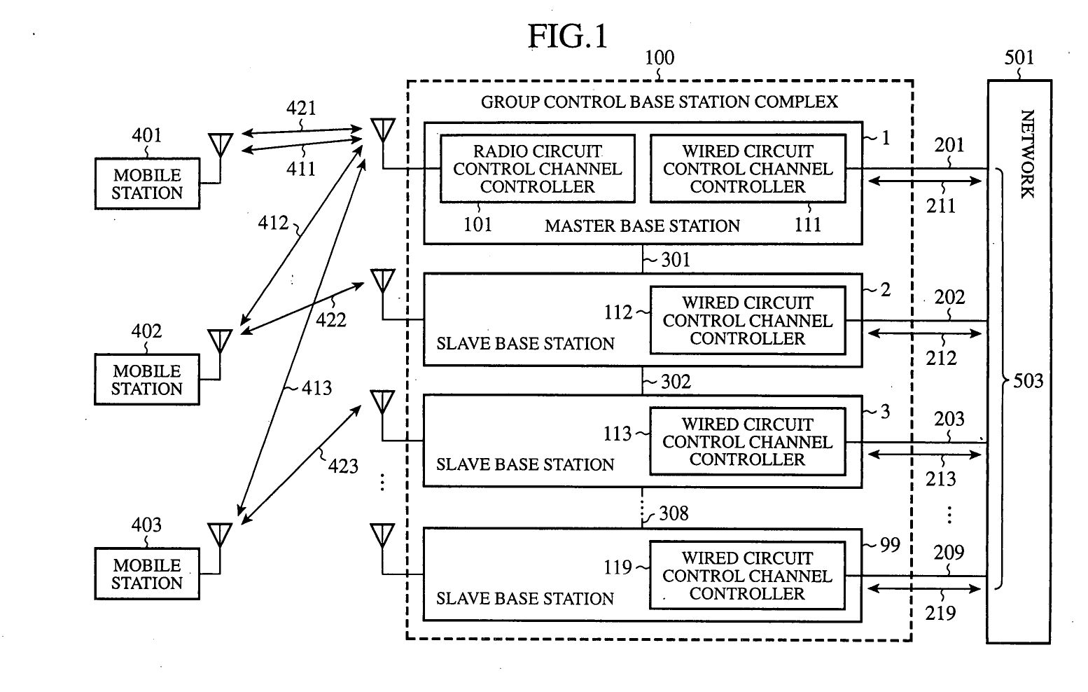

FIG. 1 is a block diagram showing a configuration of an embodiment 1 of the mobile communication system in accordance with the present invention. A group control base station complex 100 includes a plurality of radio base stations serving as a plurality of slave base stations 2, 3, . . . , and 99, and a radio base station serving as a master base station 1 for carrying out their group control. The group control base station complex 100 is assumed to include at least one slave base station. In addition, the radio base stations constituting the master base station 1 and the slave base stations 2, 3, . . . , and 99 are connected via inter-base-station circuits 301, 302, . . . , and 308.

Furthermore, the master base station 1 and slave base stations 2, 3, . . . , and 99 are each connected to a common network (telecommunication network) 501 via wired circuits 201, 202, 203, . . . , and 209. As an example of the network 501, there is a public network. The network 501 in accordance with the present invention is assumed to include switching equipment (not shown) provided between the wired circuits 201, 202, 203, . . . , and 209 and the network 501.

Mobile stations 401, 402 and 403 can communicate with the individual radio base stations 1, 2, 3, . . . , and 99 constituting the group control base station complex 100 via the radio circuits. As an example of the mobile stations 401, 402 and 403, there is a portable telephone terminal corresponding to PHS (Personal Handyphone System) or a portable information terminal such as PDA (Personal Digital Assistants).

In the mobile communication system in accordance with the present invention, only the master base station 1 among the radio base stations constituting the group control base station complex 100 includes a radio circuit control channel controller (radio circuit side controller) 101 of the radio circuits. The radio circuit side control channels transfer radio circuit call control signals 411, 412 and 413 between the individual mobile stations 401, 402 and 403 and the master base station 1.

The radio circuit call control signal defines the connection information on the communication via the radio circuit in the mobile communication system. As examples of the connection information about the communication defined by the radio circuit call control signal, there are information items about a radio base station to be connected to a mobile station via the radio circuit for the communication, the traffic channel to be used at the communication, and the slot timing in that case.

The radio circuit control channel controller 101 exchanges the radio circuit call control signal with the mobile station via the radio circuit side control channel, and controls the radio communication connection in the mobile communication system.

The radio circuit side traffic channels exchange the communication signals between the individual mobile stations 401, 402 and 403 and the radio base stations 1, 2, 3, . . . , and 99 constituting the group control base station complex 100. The master base station 1 assigns the radio circuit side traffic channels to the radio base stations that perform communications with the mobile stations among the radio base stations 1, 2, 3, . . . , and 99 constituting the group control base station complex 100.

In addition, in the mobile communication system in accordance with the present invention, the radio base stations 1, 2, 3, . . . , and 99 constituting the group control base station complex 100 include wired circuit control channel controllers (wired circuit side controllers) 111, 112, 113, . . . , and 119 of the wired circuits 201, 202, 203, . . . , and 209, respectively. The wired circuit side control channels transfer the call control signals (control signals) 211, 212, 213, . . . , and 219 between the radio base stations 1, 2, 3, . . . , and 99 constituting the group control base station complex 100 and the network 501.

The call control signals 211, 212, 213, . . . , and 219 are set in the radiobase stations 1, 2, 3, . . . , and 99, respectively, to specify the information on calls on the wired circuits with the communication network 501 side. The wired circuits 201, 202, 203, . . . , and 209 for transmitting the call control signals 211, 212, 213, . . . , and 219 are registered in a paging area 503 for incoming calls, which is provided in amemory of the switching equipment (not shown) in the network 501.

The wired circuit control channel controllers 111, 112, 113, . . . , and 119 transfer the call control signals 211, 212, 213, . . . , and 219 between the radio base stations 1, 2, 3, and 99 constituting the group control base station complex 100 and the network 501 via the control channels of the wired circuits 201, 202, 203, . . . , and 209.

The radio base stations 1, 2, 3, . . . , and 99 constituting the group control base station complex 100 each have an antenna and hardware necessary for radio communication with the mobile stations via the radio circuits, and hardware for communication with the switching equipment of the network via the wired circuits, which can be implemented by a computer that executes programs for carrying out the functions of the control channel controller.

Next, the operation of the present embodiment 1 will be described.

First, the operation in the case where the mobile station 402 makes an outgoing call, and a connection request occurs for the master base station 1 will be described. When a connection request from the mobile station 402 occurs using the radio circuit call control signal 412, the radio circuit control channel controller 101 in the master base station 1 receives the signal 412 via the antenna.

Receiving the signal 412 via the radio circuit control channel controller 101, the master base station 1 checks idle slot information and carrier sense information of the individual radio base stations in the group control base station complex 100.

According to the information on the check results, the master base station 1 determines the radio base station, traffic channel and slot timing to be assigned to the mobile station 402 for the communication connection. In this case, assume that the slave base station 2, one of the radio base stations in the group control base station complex 100, is assigned as the radio base station to communicate with the mobile station 402.

Subsequently, using the radio circuit call control signal 412, the radio circuit control channel controller 101 of the master base station 1 notifies the mobile station 402 of the slot timing and channel assigned to the mobile station 402.

On the other hand, the master base station 1 notifies the slave base station 2 of the information on the traffic channel and slot timing determined as described above, the information proper to the mobile station 402 to be connected, and the call information via the inter-base-station circuit 301.

The information proper to the mobile station 402 includes its telephone number, ID number and authentication information such as a password required for the authentication of the user. The call information includes information specifying the communication mode such as speech or data communication, a communication rate and destination information.

Thus, using the radio circuit communication signal 422, the slave base station 2 starts radio communication with the mobile station 402 via the traffic channel and slot timing notified by the master base station 1.

On the other hand, the wired circuit control channel controller 112 of the slave base station 2 carries out the call control with the network 501 side by exchanging the call control signal 212 via the control channel of the wired circuit 202. Thus, the slave base station 2 starts communication with the network 501 side via the traffic channel of the wired circuit 202.

Next, the operation will be described in the case where the mobile stations 401, 402 and 403 make connection requests using the radio circuit call control signals 411, 412 and 413 via the radio circuits.

In this case also, the master base station 1 assigns the radio base stations to be connected to the mobile stations from among the radio base stations 1, 2, 3, . . . , and 99 constituting the group control base station complex 100 including the master base station 1 itself.

More specifically, the master base station 1 checks the idle slot information and carrier sense information of the individual radio base stations in the group control base station complex 100 in the same manner as the foregoing operation. Then, according to the information on the check results, the master base station 1 determines the radio base stations to be connected to the mobile stations that send connection requests, and the traffic channels and slot timings to be assigned. In this case, assume that the base stations 1, 2 and 3 in the group control base station complex 100 are assigned as the radio base stations to communicate with the mobile stations 401, 402 and 403.

Subsequently, using the radio circuit call control signals 411, 412 and 413, the radio circuit control channel controller 101 of the master base station 1 notifies the mobile stations 401, 402 and 403 of the slot timings and channels assigned to the mobile stations.

On the other hand, the master base station 1 sends the information on the traffic channels and slot timings to the radio base stations 2 and 3 assigned to carry out the communications via the inter-base-station circuits. For example, the information is transmitted from the radio base station 1 to the radio base station 3 via the inter-base-station circuit 301, radio base station 2 and inter-base-station circuit 302.

Thus, the mobile stations 401, 402 and 403 start radio communications with the radio base stations 1, 2 and 3 via the traffic channels and slot timings using the radio circuit communication signals 421, 422 and 423.

On the other hand, the wired circuit control channel controllers 111, 112 and 113 of the radio base stations 1, 2 and 3 carry out the call control by exchanging the call control signals 211, 212 and 213 with the network 501 side via the control channels of the wired circuits 201, 202 and 203.

Thus, the radio base stations 1, 2 and 3 start communications with the network 501 side via the traffic channels of the wired circuits 201, 202 and 203. The foregoing operation is applicable to all the radio base stations constituting the group control base station complex 100.

Next, the operation in the case where an incoming call occurs to one of the mobile stations will be described.

Assume that an incoming call occurs to the mobile station 402, and that at the incoming call, the wired circuits 201, 202, 203, . . . , and 209 are registered in the paging area 503 that is reserved in the memory of the switching equipment in the network 501.

The incoming call signal from a communication party (not shown) on the network 501 side is converted to the call control signals 211, 212, 213, . . . , and 219 by the switching equipment, and is transmitted to all the wired circuits 201, 202, 203, and 209 registered in the paging area 503. Thus, the incoming call signal is sent to the individual radio base stations 1, 2, 3, . . . , and 99 via the wired circuits 201, 202, 203, and 209 as the call control signals 211, 212, 213, . . . , and 219.

Next, the master base station 1 identifies the destination of the incoming call signal from the call control signal 211 received by the wired circuit control channel controller 111. Subsequently, the radio circuit control channel controller 101 of the master base station 1 transmits the incoming call signal to the mobile station 402 using the radio circuit call control signal 412.

Receiving the incoming call signal, the mobile station 402 transmits a connection request to the master base station 1 using the radio circuit call control signal 412.

The subsequent operation is the same as that when the mobile station 402 transmits the connection request at the outgoing call. More specifically, in response to the connection request from the mobile station 402, the master base station 1 determines the radio base station, channel and slot timing to be assigned from the idle slot information and carrier sense information of the individual radio base stations to be subjected to the group control. Assume that the slave base station 2 is assigned as the radio base station to carry out communication with the mobile station 402.

Subsequently, using the radio circuit call control signal 412, the radio circuit control channel controller 101 of the master base station 1 notifies the mobile station 402 of the slot timing and channel to be assigned to the mobile station 402.

On the other hand, the master base station 1 sends to the slave base station 2 assigned to carry out the communication connection, not only the information on the channel and slot timing used for the communication, but also the information proper to the mobile station to carry out the communication connection and the call information via the inter-base-station circuit 301.

The information proper to the mobile station that establishes the communication connection includes its telephone number, ID number and authentication information. On the other hand, the call information includes information specifying the communication mode such as speech or data communication, a communication rate and destination information.

Thus, using the radio circuit communication signal 422, the mobile station 402 and slave base station 2 start radio communication via the traffic channel and slot timing notified by the master base station 1.

On the other hand, the wired circuit control channel controller 112 of the slave base station 2 establishes the call connection sequence in response to the incoming call from the communication party using the call control signal 212 via the control channel of the wired circuit 202. Thus, the mobile station 402 starts communication with the communication party via the slave base station 2, wired circuit 202 and network 501.

Next, the operation in the case where incoming calls occur to the mobile stations 401, 402 and 403 will be described.

In this case, incoming call signals from communication parties (not shown) connected to the network 501 to the mobile stations 401, 402 and 403 are transmitted from the switching equipment of the network 501 to the individual radio base stations 1, 2, 3, . . . , and 99 via the wired circuits 201, 202, 203, . . . , and 209 registered in the paging area 503 as the call control signals 211, 212, 213, . . . , and 219.

Subsequently, the master base station 1 reads the incoming call signals from the call control signal 211. Thus, the radio circuit control channel controller 101 of the master base station 1 transmits the incoming call signals to the mobile stations 401, 402 and 403 using the radio circuit call control signals 411, 412 and 413.

Receiving the incoming call signals, the mobile stations 401, 402 and 403 transmit connection requests to the master base station 1 using the radio circuit control signals 411, 412 and 413. When the radio circuit control channel controller 101 receives the connection requests from the mobile stations 401, 402 and 403, the master base station 1 assigns the radio base stations to carry out the communications from among the radio base stations 1, 2, 3, . . . , and 99 that are subjected to the group control.

More specifically, the master base station 1 checks the idle slot information and carrier sense information of the individual radio base stations in the group control base station complex 100 in the same manner as the foregoing operation. Then, according to the information on the check results, the master base station 1 determines the radio base stations to be connected to the mobile stations that send the connection requests, and the traffic channels and slot timings to be assigned. In this case, assume that the base stations 1, 2 and 3 are assigned as the radio base stations to communicate with the mobile stations 401, 402 and 403.

Subsequently, using the radio circuit call control signals 411, 412 and 413, the radio circuit control channel controller 101 of the master base station 1 notifies the mobile stations 401, 402 and 403 of the slot timings and channels assigned to the mobile stations.

On the other hand, the master base station 1 sends the information on the traffic channels and slot timings to the radio base stations 2 and 3 via the inter-base-station circuits. For example, the information is transmitted from the radio base station 1 to the radio base station 3 via the inter-base-station circuits 301 and 302.

Thus, the mobile stations 401, 402 and 403 and the radio base stations 1, 2 and 3 start radio communications using the radio circuit communication signals 421, 422 and 423 via the traffic channels and slot timings which are notified as described above.

On the other hand, the wired circuit control channel controllers 111, 112 and 113 of the radio base stations 1, 2 and 3 establish the call connection sequence with the communication parties in response to the incoming calls using the call control signals 211, 212 and 213 via the control channels of the wired circuits 201, 202 and 203.

Thus, the mobile stations 401, 402 and 403 start communications with the communication parties via the radio base stations 1, 2 and 3, wired circuits 201, 202 and 203 and network 501. The foregoing operation is the same for all the radio base stations constituting the group control base station complex 100.

As described above, the present embodiment 1 is characterized in that only the master base station 1 is provided with the radio circuit control channel controller 101 for controlling the radio circuit side control channels, and that the individual radio base stations 1, 2, 3, . . . , and 99 constituting the group control base station complex 100 are provided with the wired circuit control channel controllers 111, . . . 112, 113, . . . , and 119 for controlling the wired circuit side control channels.

The configuration enables the radio base stations 1, 2, 3, . . . , and 99 to carry out the call control with the network 501 via the wired circuits on a call by call basis. Accordingly, it can scatter the processing load required for the wired circuit side call connection over the individual radio base stations 1, 2, 3, . . . , and 99.

Consequently, since the control load is not concentrated on the master base station 1, the number of the radio base stations to be subjected to the group control can be increased more easily than in the conventional system without modifying the hardware of the computer constituting the master base station 1. In addition, it can readily implement the multichannel connection in accordance with the traffic conditions.

Furthermore, providing the radio base stations 1, 2, 3, and 99 with the wired circuit control channel controllers 111, 112, 113, . . . , and 119, respectively, makes it possible to add radio base stations easily to the group control base station complex 100.

More specifically, as for the conventional system, since only the master base station carries out the wired circuit side control of the slave base stations, the wired circuit of a radio base station to be added newly to the group control base station complex must be connected in a sequence considering the control by the master base station.

In contrast with this, according to the present invention, since the radio base stations 1, 2, 3, . . . , and 99 carry out the call control of the wired circuits individually, the wired circuits 201, 202, 203, . . . , and 209 can be wired without considering the sequence of their connection.

Moreover, since only the master base station 1 is provided with the radio circuit control channel controller 101 for controlling the radio circuit side control channels, the number of the control channels of the radio circuits does not increase with an increase of the number of the radio base stations to be subjected to the group control. As a result, the present embodiment 1 of the system can make effective use of the resources of the control channels of the radio circuits, the number of the time slots of which has the upper limit.

### Embodiment 2

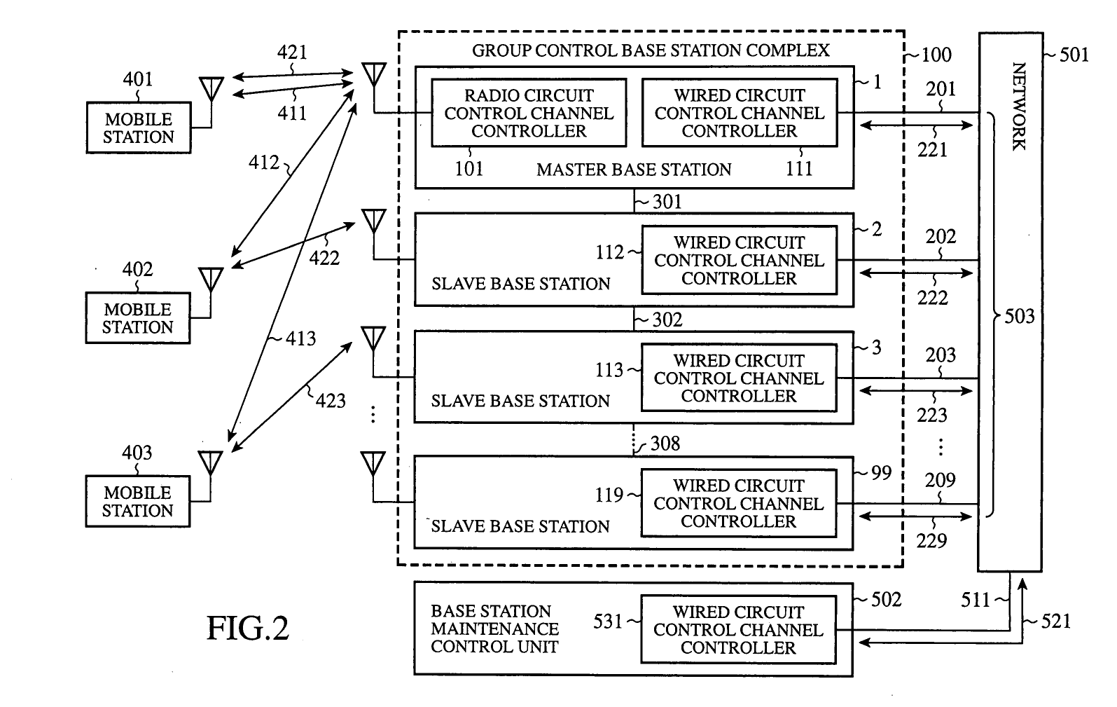

FIG. 2 is a block diagram showing a configuration of an embodiment 2 of the mobile communication system in accordance with the present invention. The present embodiment 2 includes, in addition to the configuration of the embodiment 1 as shown in FIG. 1, a radio base station maintenance control unit 502 connected to the system via the network 501 and a wired circuit 511.

The base station maintenance control unit 502 includes a wired circuit control channel controller (wired circuit side controller) 531 for controlling the control channel of the wired circuit 511. The control channel of the wired circuit 511 transfers a control signal (maintenance information) 521 between the base station maintenance control unit 502 and the network 501.

The radio base station maintenance control unit 502 can establish the communication connection with the radio base stations 1, 2, 3, . . . , and 99 via the wired circuits 201, 202, 203, . . . , and 209 using the wired circuit control channel controller 531. Thus, the radio base station maintenance control unit 502 can carry out the maintenance control of the individual radio base stations 1, 2, 3, . . . , and 99 directly using maintenance control signals (maintenance information) 221, 222, 223, . . . , and 229 exchanged via the wired circuits 201, 202, 203, . . . , and 209. The maintenance processing of the radio base stations includes call surveillance; fault surveillance; blocking, blocking release and remote control of the radio circuits, wired circuits and control channels; traffic data acquisition; and a variety of tests.

The radio base station maintenance control unit 502 can be implemented by a computer that includes hardware for communicating with the switching equipment of the network 501 via the wired circuit 511, and that executes programs for carrying out the functions of the control channel controller 531.

Next, the operation of the present embodiment 2 will be described.

In the following description, only the operation of the maintenance control of the radio base stations by the radio base station maintenance control unit 502, which is characteristic of the present embodiment 2, will be described with omitting the description of the operation similar to that of the foregoing embodiment 1. In addition, the operation will be described by way of example of the maintenance control of the slave base station 2 by the base station maintenance control unit 502.

First, the base station maintenance control unit 502 generates control information necessary for the maintenance of the slave base station 2. Subsequently, the wired circuit control channel controller 531 transmits the control information to the network 501 side as the control signal 521 via the control channel of the wired circuit 511.

The switching equipment (not shown) of the network 501 transmits the control signal 521 to the slave base station 2 as a maintenance control signal 222 via the control channel of the wired circuit 202. According to the control information obtained from the maintenance control signal 222, the slave base station 2 carries out the maintenance processing of its own.

When information to be transmitted to the base station maintenance control unit 502 occurs during its own maintenance processing, the slave base station 2 transfers the information to the wired circuit control channel controller 112. The wired circuit control channel controller 112 transmits the information to the network 501 side via the control channel of the wired circuit 202 as the maintenance control signal 222.

The switching equipment (not shown) of the network 501 transmits the maintenance control signal 222 to the base station maintenance control unit 502 as the control signal 521 via the control channel of the wired circuit 511. The base station maintenance control unit 502 carries out the succeeding maintenance control using the information obtained from the control signal 521.

The base station maintenance control unit 502 carries out similar maintenance control for the other radio base stations 1, 3, . . . , and 99 constituting the group control base station complex 100.

As described above, the present embodiment 2 is characterized in that the base station maintenance control unit 502 carries out the wired circuit side maintenance control directly to the individual radio base stations 1, 2, 3, and 99 constituting the group control base station complex 100.

In the conventional system described above, only the master base station comprises the controller for controlling the wired circuit side control channels, and controls the wired circuit side maintenance processing of the radio base stations undergoing the group control.

Thus, in the conventional system, the master base station must bear the load of the wired circuit side maintenance control by itself, which increases with the number of the radio base stations to be subjected to the group control. Accordingly, as long as the master base station is configured using the computer with the same performance, it is inevitable that the number of the radio base stations to be subjected to the group control is limited.

In contrast with this, in the present embodiment 2, the base station maintenance control unit 502 carries out the maintenance control of the individual radio base stations 1, 2, 3, . . . , and 99 directly via the network 501 independently of the configuration of the group control base station complex 100.

Accordingly, even though the number of the radio base stations constituting the group control base station complex 100 increases, only the base station maintenance control unit 502 carries out the maintenance control for the individual radio base station, thereby being able to prevent the concentration of the processing load on one apparatus.

In this way, the present embodiment 2 can resultantly scatter the processing load of the wired circuit side maintenance control over the individual radio base stations 1, 2, 3, . . . , and 99. Thus, as the foregoing embodiment 1, the present embodiment 2 can increase the number of the radio base stations to be subjected to the group control as compared with the conventional system without modifying the hardware configuration of the computer constituting the master base station 1. In addition, it can easily implement the multichannel connection in accordance with the traffic conditions.

Furthermore, even if the master base station 1 becomes uncontrollable because of some fault, the maintenance control can be continued of the other radio base stations, the slave base stations 2, 3, . . . , and 99, constituting the group control base station complex 100. This offers an advantage of being able to facilitate the procedure of continuing the operation of the group control base station complex 100 by switching the master base station to the slave base station.

In this case, the slave base station taking the place of the master base station has the software installed, which will cause the slave base station to operate as the radio circuit control channel controller, from the base station maintenance control unit 502 via the network 501, for example. Alternatively, it is also possible for each radio base station to include the radio circuit controller to take the place of the master base station using a parameter.

### Embodiment 3

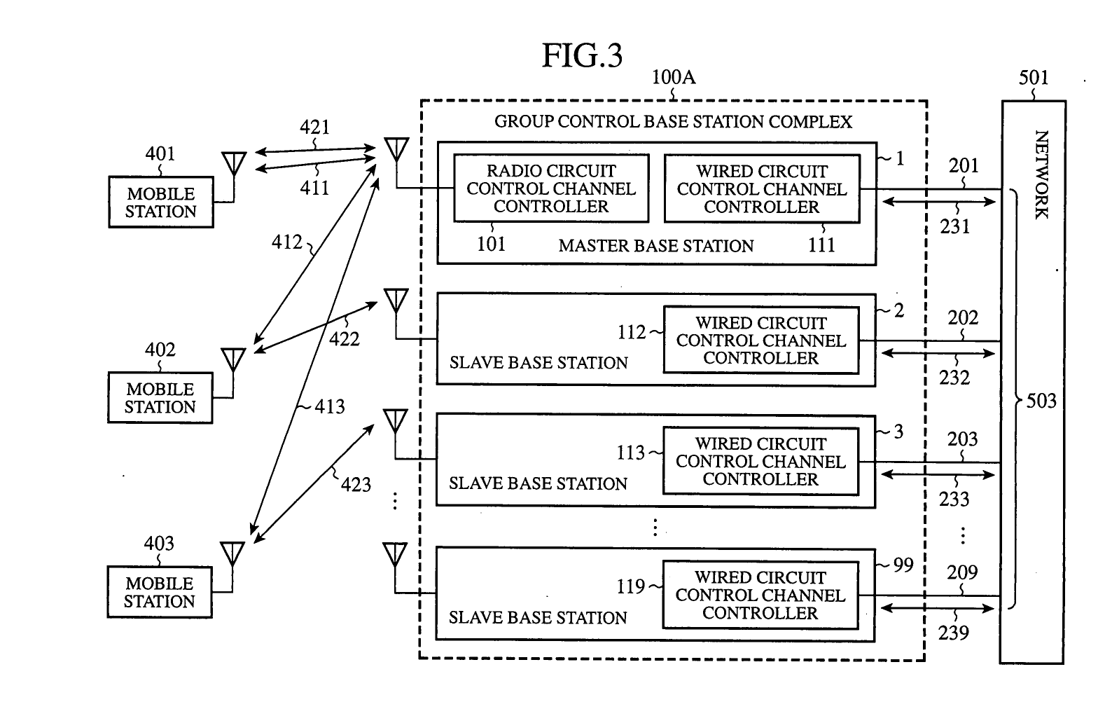

FIG. 3 is a block diagram showing a configuration of an embodiment 3 of the mobile communication system in accordance with the present invention. Although the present embodiment 3 has a basic configuration common with the foregoing embodiment 1 as shown in FIG. 1, it does not include the inter-base-station circuits 301, 302, 303, . . . , and 308 in the group control base station complex 100A.

Instead of using the inter-base-station circuits, the present embodiment employs the wired circuit control channel controllers 111, 112, 113, . . . , and 119 to exchange the control signals between the radio base stations using inter-base-station control signals (control signals) 231, 232, 233, and 239.

Next, the operation of the present embodiment 3 will be described.

The operation will be described by way of example in which when the mobile station 402 makes an outgoing call, a connection request is sent to the master base station 1. In response to the connection request from the mobile station 402 using the radio circuit call control signal 412, the radio circuit control channel controller 101 of the master base station 1 receives the signal 412 via the antenna.

Receiving the connection request with the radio circuit control channel controller 101, the master base station 1 checks the idle slot information and carrier sense information of the individual radio base stations in the group control base station complex 100 via the network 501. More specifically, the wired circuit control channel controller 111 in the master base station 1 exchanges the base station control signals on the idle slot information and carrier sense information with the wired circuit control channel controllers of the other radio base stations via the control channel of the wired circuit 201 and the network 501.

According to the information on the check results, the master base station 1 determines the radio base station, traffic channel and slot timing to be assigned to the mobile station 402 for the communication connection. In this case, assume that the slave base station 2, one of the radio base stations in the group control base station complex 100A, is assigned as the radio base station to communicate with the mobile station 402.

Subsequently, using the radio circuit call control signal 412, the radio circuit control channel controller 101 of the master base station 1 notifies the mobile station 402 of the slot timing and channel assigned to the mobile station 402.

On the other hand, the master base station 1 sends to the wired circuit control channel controller 111 the information on the traffic channel and slot timing determined as described above, the information proper to the mobile station 402 to be connected, and the call information.

The information proper to the mobile station 402 includes its telephone number, ID number and authentication information such as a password required for the authentication of the user. The call information includes information specifying the communication mode such as speech or data communication, a communication rate and destination information.

The wired circuit control channel controller 111 transmits the information on the traffic channel and slot timing, which are determined as described above, to the switching equipment (not shown) of the network 501 via the control channel of the wired circuit 201 as the inter-base-station control signal 231 addressed to the slave base station 2.

According to the address of the inter-base-station control signal 231, the switching equipment (not shown) of the network 501 transmits the signal 231 to the slave base station 2 as the inter-base-station control signal 232 via the control channel of the wired circuit 202.

The wired circuit control channel controller 112 of the slave base station 2 carries out the communication processing according to the information it receives from the network 501 side as the inter-base-station control signal 232. Thus, the slave base station 2 starts the radio communication with the mobile station 402 via the traffic channel and slot timing determined by the master base station 1.

On the other hand, as in the foregoing embodiment 1, the wired circuit control channel controller 112 of the slave base station 2 carries out the call control with the network 501 side by exchanging the call control signal 212 via the control channel of the wired circuit 202. Thus, the slave base station 2 starts communication with the network 501 side.

The foregoing operation is also applicable to the other radio base stations, and the inter-base-station control signals 231, 232, 233, . . . , and 239 are exchanged between the radio base stations.

As described above, the present embodiment 3 is characterized in that the wired circuit control channel controllers 111, 112, 113, . . . , and 119 exchange the control signals between the radio base stations constituting the group control base station complex 100A via the wired circuits 201, 202, 203, . . . , and 209 and the network 501.

With the configuration, the individual radio base stations can obviate not only the need for the inter-base-station circuits, but also the need for the configuration for exchanging the control signals via the inter-base-station circuits. As a result, it can facilitate the wiring involved in installing the radio base station.

Although the present embodiment 3 employs the foregoing embodiment 1 as the basic configuration, the present invention can also employ the foregoing embodiment 2 as the basic configuration.

### Embodiment 4

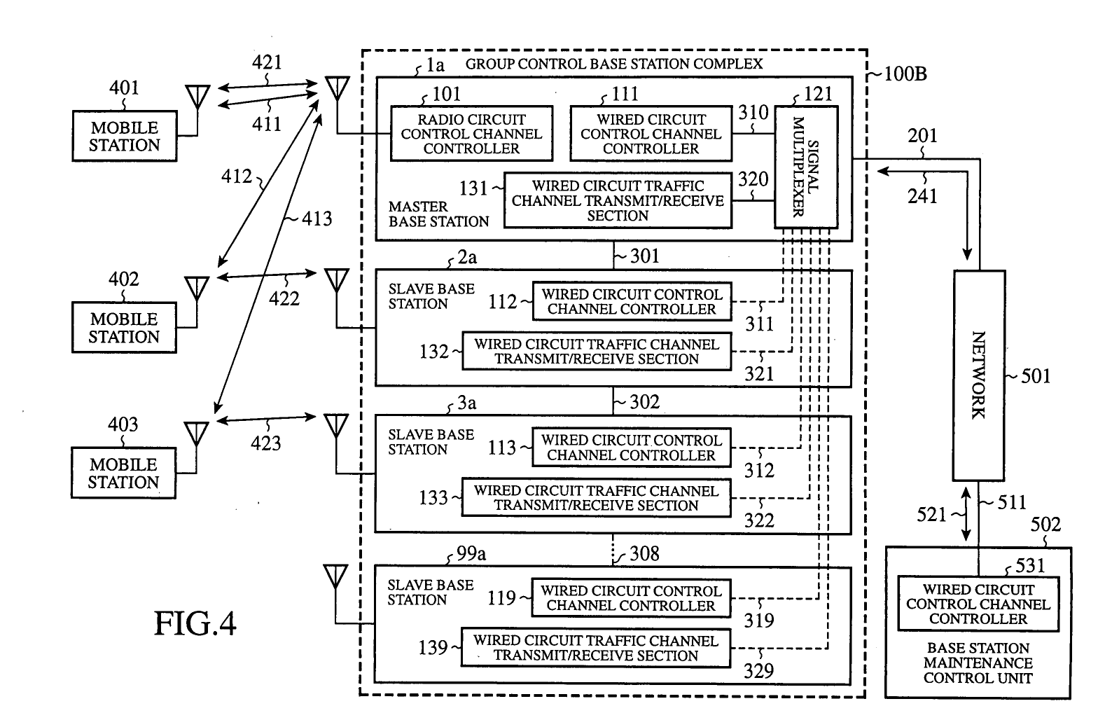

FIG. 4 is a block diagram showing a configuration of an embodiment 4 of the mobile communication system in accordance with the present invention. The group control base station complex 100B comprises a plurality of radio base stations functioning as a plurality of slave base stations 2a, 3a, and 99a, and a radio base station functioning as a master base station 1a for carrying out the group control of them. The master base station 1a and slave base stations 2a, 3a, . . . , and 99a are interconnected through the inter-base-station circuits 301, 302, . . . , and 308.

The master base station 1a and slave base stations 2a, 3a, . . . , and 99a include the wired circuit control channel controllers 111, 112, 113, . . . , and 119 and wired circuit traffic channel transmit/receive sections 131, 132, 133, . . . , and 139, respectively.

Unlike those of the foregoing embodiment 1, the wired circuit control channel controllers 111, 112, 113, . . . , and 119 exchange the control signals 310, 311, 312, . . . , and 319 between the radio base stations 1a, 2a, 3a, . . . , and 99a constituting the group control base station complex 100B and the network 501 via a signal multiplexer 121.

When carrying out the call control between the radio base stations 1a, 2a, 3a, . . . , and 99a and the network 501 side, the control signals 310, 311, 312, . . . , and 319 correspond to the call control signals 211, 212, 213, . . . , and 219 described in the foregoing embodiment 1.

In this case, the control signals 310, 311, 312, . . . , and 319 are set for the radio base stations 1a, 2a, 3a, . . . , and 99a, respectively, to specify the information about the calls of the wired circuit communications with the network 501 side.

In contrast, when controlling the maintenance processing for the radio base stations 1a, 2a, 3a, . . . , and 99a, the control signals 310, 311, 312, . . . , and 319 correspond to the maintenance control signals 221, 222, 223, . . . , and 229 described in the foregoing embodiment 2.

In this case, the control signals 310, 311, 312, . . . , and 319 are assigned the information on the maintenance processing by the individual radio base stations 1a, 2a, 3a, . . . , and 99a controlled by the base station maintenance control unit 502.

The wired circuit traffic channel transmit/receive sections 131, 132, 133, . . . , and 139 exchange the communication signals 320, 321, 322, . . . , and 329 between the radio base stations 1a, 2a, 3a, . . . , and 99a and the network 501 side via the signal multiplexer 121 and the traffic channel of the wired circuit 201.

In the present embodiment 4 also, only the master base station 1a includes the radio circuit control channel controller 101. As in the foregoing embodiment 1, the radio circuit control channel controller 101 exchanges the radio circuit call control signals with the mobile stations via the radio circuit side control channels to control the radio communication connection in the mobile communication system.

The master base station 1a further includes the signal multiplexer 121. The signal multiplexer 121 multiplexes the control signals and communication signals to be transmitted from the wired circuit control channel controllers and wired circuit traffic channel transmit/receive sections to the network 501 side to generate a multiplexed signal 241, and transmits it to the network 501 side.

In addition, the signal multiplexer 121 passes on the control signals and communication signals from the network 501 side to the radio base stations these signal are directed to. The signal multiplexer 121 is communicatively connected to the wired circuit control channel controllers and wired circuit traffic channel transmit/receive sections via the inter-base-station circuits 301, 302, 303, . . . , and 308.

The remaining components designated by the same reference numerals are the same or like components to those of FIGS. 1 and 2, and operate like their counterparts in the foregoing embodiments 1 and 2. Accordingly, their description is omitted here.

The slave base stations 2a, 3a, . . . , and 99a each include an antenna and hardware necessary for the radio communications with the mobile stations via the radio circuit, and are implemented by a computer that executes programs for carrying out the functions of the control channel controller and traffic channel transmit/receive section.

On the other hand, the master base station 1a includes hardware for communicating with the switching equipment of the network 501 via the wired circuit in addition to the antenna and hardware necessary for the radio communications with the mobile stations via the radio circuit, and is implemented by a computer that executes programs for carrying out the functions of the control channel controllers, traffic channel transmit/receive section and signal multiplexer.

Next, the operation of the present embodiment 4 will be described.

For example, the operation will be described in the case where any of the mobile stations 401, 402 and 403 make connection requests using the radio circuit call control signals 411, 412 and 413 via the radio circuits.

Receiving the connection requests with the radio circuit control channel controller 101, the master base station 1a checks the idle slot information and carrier sense information of the individual radio base stations in the group control base station complex 100B.

According to the information on the check results, the master base station 1a determines the radio base stations, traffic channels and slot timings to be assigned to the mobile stations that send the communication connection requests. In this case, assume that the radio base stations 1a, 2a, 3a, and 99a in the group control base station complex 100B are assigned as the radio base stations to communicate with the mobile stations 401, 402 and 403.

Subsequently, using the radio circuit call control signals 411, 412 and 413, the radio circuit control channel controller 101 of the master base station 1a notifies the mobile stations 401, 402 and 403 of the channels and slot timings assigned to the mobile stations.

Subsequently, the master base station 1a sends the information on the traffic channels and slot timings to the radio base stations 2a and 3a, which are selected to make communications via the inter-base-station circuits. As for the radio base station 3a, for example, the master base station 1a sends it the information via the inter-base-station circuit 301, radio base station 2a and inter-base-station circuit 302.

In this way, the mobile stations 401, 402 and 403 start radio communications with the radio base stations 1a, 2a, 3a, and 99a using the radio circuit communication signals 421, 422 and 423 via the traffic channels and slot timings notified as described above.

On the other hand, the wired circuit control channel controllers 111, 112, 113, . . . , and 119 of the radio base stations 1a, 2a, 3a, . . . , and 99a transmit the control signals 310, 311, 312, . . . , and 319 to the signal multiplexer 121 as the call control signals.

The signal multiplexer 121 multiplexes the control signals 310, 311, 312, . . . , and 319 to generate the multiplexed signal 241, and carries out the call control with the network 501 side via the control channel of the wired circuit 201. Thus, the radio base stations 1a, 2a, 3a, . . . , and 99a start communications with the network 501 side.

The foregoing operation is the same for all the radio base stations constituting the group control base station complex 100B.

Next, the operation in the case where incoming calls occur to any of the mobile stations 401, 402 and 403 will be described.

Incoming call signals to be sent from communication parties (not shown) connected the network 501 to the mobile stations 401, 402 and 403 are transmitted from the switching equipment (not shown) of the network 501 to the radio base station 1a via the traffic channel of the wired circuit 201 as the communication signal 241 for the individual base stations connected to the switching equipment.

The signal multiplexer 121 of the radio base station 1a demultiplexes the communication signal 241 from the network 501 side to signals corresponding to the number of the base stations, and supplies them to the wired circuit control channel controllers 111, 112, 113, . . . , and 119 of the individual radio base stations 1a, 2a, 3a, . . . , and 99a in the group control base station complex 100b as the control signals 310, 311, 312, and 319.

When the wired circuit traffic channel transmit/receive section 131 receives the incoming call signal as the communication signal 320, the radio circuit control channel controller 101 of the master base station 1a transmits the incoming call signal to the mobile stations 401, 402 and 403 using the radio circuit call control signals 411, 412 and 413.

Receiving the incoming call signal, the mobile stations 401, 402 and 403 transmit connection requests to the master base station 1a using the radio circuit control signals 411, 412 and 413. In response to the reception of the connection requests by the radio circuit control channel controller 101, the master base station 1a assigns the radio base stations to carry out communications from among the radio base stations 1a, 2a, 3a, and 99a undergoing the group control.

More specifically, the master base station 1a checks the idle slot information and carrier sense information of the individual radio base stations in the group control base station complex 100B via the inter-base-station circuits 301, 302, and 308 in the same manner as described above. Then, according to the information on the check results, the master base station 1a determines the radio base stations to be connected to the mobile stations having sent the connection requests, and traffic channels and slot timings to be assigned to the mobile stations. In this case, assume that the radio base stations 1a, 2a, 3a, and 99a are assigned as the radio base stations that communicate with the mobile stations 401, 402 and 403.

Subsequently, the radio circuit control channel controller 101 of the master base station 1a notifies the mobile stations 401, 402 and 403 of the channels and the slot timings using the radio circuit call control signals 411, 412 and 413.

On the other hand, the master base station 1a notifies the radio base stations 1a, 2a, 3a, . . . , and 99a, which are assigned as the base stations to make communications with the mobile stations 401, 402 and 403, of the information on the traffic channels and slot timings determined as described above via the inter-base-station circuits. For example, the slave base station 99a receives information via the inter-base-station circuits 301, 302, . . . , and 308.

In this way, the mobile stations 401, 402 and 403 and the radio base stations 1a, 2a, 3a, . . . , and 99a start radio communications using the radio circuit communication signals 421, 422 and 423 via the traffic channels and slot timings.

In addition, the wired circuit control channel controllers 111, 112, 113, . . . , and 119 of the radio base stations 1a, 2a, 3a, . . . , and 99a transfer the control signals 310, 311, 312, and 319 to the signal multiplexer 121 as the incoming call responses.

The signal multiplexer 121 multiplexes the control signals 310, 311, 312, . . . , and 319 to generate the single multiplexed signal 241, and transmits it to the network 501 side via the control channel of the wired circuit 201, thereby establishing the call connection sequence by making the incoming call response to the communication parties. Thus, the mobile stations 401, 402 and 403 start communications with the communication parties via the radio base stations 1a, 2a, 3a, and 99a, the wired circuit 201 and network 501.

The communication signals to be transmitted from the communication parties to the mobile stations 401, 402 and 403 are transmitted from the switching equipment (not shown) of the network 501 to the signal multiplexer 121 of the master base station 1a via the traffic channel of the wired circuit 201.

The signal multiplexer 121 transfers the communication signals to the wired circuit traffic channel transmit/receive sections 131, 132 and 133 as the communication signals 320, 321, 322, . . . , and 329. Receiving the communication signals 320, 321, 322, . . . , and 329 with the wired circuit traffic channel transmit/receive sections 131, 132, 133, . . . , and 139, the radio base stations 1a, 2a, 3a, . . . , and 99a transmit them to the mobile stations 401, 402 and 403 using the radio circuit communication signals 421, 422 and 423 via the traffic channels of the radio circuits.

The foregoing operation is the same for all the radio base stations constituting the group control base station complex 100B.

Next, the maintenance control operation of the radio base stations by the radio base station maintenance control unit 502 will be described. It will be described here by way of example in which the base station maintenance control unit 502 carries out the maintenance control of the radio base stations 1a, 2a, 3a, . . . , and 99a.

First, the base station maintenance control unit 502 generates the control information necessary for the maintenance of the radio base stations 1a, 2a, 3a, . . . , and 99a. Subsequently, the wired circuit control channel controller 531 transmits the control information to the network 501 side via the control channel of the wired circuit 511 as the control signal 521 addressed to the individual radio base stations.

The switching equipment (not shown) of the network 501 transmits the control signal 521 to the signal multiplexer 121 via the control channel of the wired circuit 201. The signal multiplexer 121 transmits the control signal 521 to the radio base stations 1a, 2a, 3a, . . . , and 99a as the control signals 310, 311, 312, . . . , and 319 directed to the destinations.

According to the control information obtained from the control signals 310, 311, 312, . . . , and 319, the radio base stations 1a, 2a, 3a, . . . , and 99a carry out their own maintenance processing.

When information to be transmitted to the base station maintenance control unit 502 occurs during their own maintenance processing, the radio base stations 1a, 2a, 3a, . . . , and 99a transfer the information to the wired circuit control channel controllers 111, 112, 113, . . . , and 119, respectively. The wired circuit control channel controllers 111, 112, 113, and 119 transmit the information to the signal multiplexer 121 as the control signals 310, 311, 312, . . . , and 319.

The signal multiplexer 121 multiplexes the control signals 310, 311, 312, . . . , and 319 to the single multiplexed signal 241, and transmits it to the network 501 side via the control channel of the wired circuit 201.

The switching equipment (not shown) of the network 501 transmits the multiplexed signal 241 to the base station maintenance control unit 502 as the control signal 521 via the control channel of the wired circuit 511. The control signal 521 is received by the wired circuit control channel controller 531 of the base station maintenance control unit 502.

Using the information obtained from the control signal 521 received by the wired circuit control channel controller 531, the base station maintenance control unit 502 carries out the succeeding maintenance control of the radio base stations 1a, 2a, 3a, . . . , and 99a.

The maintenance control is assumed to be performed on the remaining radio base stations constituting the group control base station complex 100B in the same manner.

As described above, the present embodiment 4 is characterized in that the signal multiplexer 121 of the master base station 1a multiplexes to the single multiplexed signal 241 the control signals and communication signals including information on the call control and maintenance control, which are exchanged between the radio base stations 1a, 2a, 3a, and 99a and the network 501 side, and carries out the control and communications with the network 501 via the single wired circuit 201.

With the configuration, it becomes possible to configure the group control base station complex 100B by connecting only the master base station 1a among the plurality of radio base stations undergoing the group control to the network 501 via the wired circuit 201, thereby facilitating the wiring for installing the radio base stations.

In addition, as the foregoing embodiments 1-3, the present embodiment 4 has the radio base stations 1a, 2a, 3a, . . . , and 99a carry out the wired circuit side control processing individually. Accordingly, it can scatter the processing load required for the wired circuit side control over the individual radio base stations 1a, 2a, 3a, . . . , and 99a.

Consequently, the hardware configuration of the computer constituting the master base station 1a need not be modified, and the control load is not concentrated on the master base station 1a. As a result, the number of the radio base stations to be subjected to the group control can be increased more easily than in the conventional system, and the multichannel connection can be readily implemented in accordance with the traffic conditions.

1. A mobile communication system including a plurality of radio base stations which are connected to a common telecommunication network via a wired circuit, and communicate with mobile stations via radio circuits, said mobile communication system comprising:
wired circuit side controllers installed in said plurality of radio base stations, respectively, to carry out control processing via the wired circuit; and
a master base station that consists of at least one of said plurality of radio base stations with the remaining radio base stations being set as slave base stations, and includes a radio circuit side controller for carrying out the control processing via the radio circuits.

2. The mobile communication system according to claim 1, further comprising a base station maintenance control unit including a wired circuit side controller that is connected to said telecommunication network via a wired circuit, and carries out the control processing via the wired circuit, wherein said base station maintenance control unit controls maintenance processing of said radio base stations by causing said wired circuit side controller to exchange maintenance information with the wired circuit side controllers of said individual radio base stations.

3. The mobile communication system according to claim 1, said plurality of radio base stations exchange control signals with each other by said wired circuit side controllers installed in said plurality of radio base stations via the wired circuit and telecommunication network.

4. The mobile communication system according to claim 1, further comprising a signal multiplexer that is connected to said telecommunication network via the wired circuit to transfer control signals between said plurality of radio base stations and said telecommunication network, and that multiplexes the control signals to be transmitted from said plurality of radio base stations to said telecommunication network side, and transmits the multiplexed control signals to said telecommunication network side via the wired circuit.

5. A master base station consisting of at least one of a plurality of radio base stations that are connected to a common telecommunication network via wired circuits, communicate with mobile stations via radio circuits, and include wired circuit side controllers, respectively, for carrying out control processing via the wired circuits, said master base station comprising:
a radio circuit side controller for carrying out control processing via the radio circuits, wherein
said master base station controls said radio base stations other than said master base station as slave base stations.

6. A slave base station of a mobile communication system including a plurality of radio base stations that are connected to a common telecommunication network via wired circuits, and communicate with mobile stations via radio circuits, at least one of said plurality of radio base stations being made a master base station, and the radio base stations other than said master base station being made a slave base station, said slave base station comprising:
a wired circuit side controller for carrying out control processing via the wired circuit, wherein
the control processing of said slave base station via its own radio circuit is carried out by said master base station.
